(19) United States
(12) Patent Application Publication
(10) Pub. No.: US 2008/0281852 A1
(43) Pub. Date: Nov. 13, 2008

(54) METHOD, APPARATUS AND COMPUTER PROGRAM PRODUCT FOR PROVIDING AN ADAPTIVE FRAMEWORK FOR A METADATA-CONTEXT SWITCH

(75) Inventor: Sailesh Sathish, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/747,578

(22) Filed: May 11, 2007

(51) Int. Cl. G06F 17/30

(52) U.S. Cl. 707/102; 707/E17.005

(57) ABSTRACT

An apparatus for providing an adaptive framework for a metadata-context switch may include a processing element. The processing element may be configured to receive, from an application, a query for data, to determine whether to provide a response to the query in a context view or in a metadata view based on an indication received from the application, and to generate the metadata view based at least in part on a context model and rules specified by the application in response to determining to provide the response in the metadata view.

### TECHNOLOGICAL FIELD

Embodiments of the present invention relate generally to data management and, more particularly, relate to a method, apparatus, and computer program product for providing an adaptive framework for a metadata-context switch.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In some applications, it may be desirable for the application to have the ability to access information or objects from other devices. For example, separate devices creating multimedia content related to a particular event may be desirably placed in communication in order to share their corresponding multimedia content related to the particular event. In this regard, a user of a mobile terminal, or an application operable at the mobile terminal, may request information from another device over communication links.

Despite the ability to enable information sharing between devices, information sharing may be complicated when it is desirable to share specific information, for example, related to a particular event, topic, time period, etc. The complexities introduced in such situations may relate to the fact that different devices may classify or label content in different and unique ways and thus, identification of data that may be of interest or related to a particular topic may be problematic. Context data may be associated with content stored on a device in order to provide information which might assist in identifying data of interest. Context data is data that characterizes a particular situation at any point in time and may be either static or dynamic. Metadata is another form of information which may be associated with content to assist in ordering and identifying the content. Metadata may be considered to be data that provides additional data about data and is generally thought of as being static. When media content is recorded or an application inquires about situational characteristics related to an object, the context data associated with the content or object may be referenced. The context data may be used by applications for different purposes, such as generating metadata or performing an adaptation based on the context. When used for adaptation purposes, no context is typically stored, but is instead used dynamically.

Delivery Context Interface (DCI) is a mechanism through which applications can access delivery context information using, for example, a Document Object Model (DOM) like interface. Accordingly, applications can register event listeners on property nodes that initiate events based on property or other changes. In this regard, DCI provides interfaces for applications that utilize delivery context information. DCI provides a tree-like representation of context data on a device that can be represented in a hierarchical manner conforming to some standard ontology. However, even though context representation may be used by applications for adaptation or metadata recording as described above, some applications may use metadata itself rather than context data for achieving the corresponding function associated with the application. For example, instead of context data, a particular application may perform a function on the basis of a version number for particular software or based on the manufacturer of the software. These characteristics may be stored in metadata rather than context data.

Since context data may often be represented as a tree structure, each node in the tree may represent a context node providing structure for dynamic values that comprise a context value. In addition, each node (e.g., context node) may include structures for metadata that characterize the context node (e.g., provide additional information about the context node). However, metadata structures can currently vary widely depending upon a number of factors. For example, different users may assign different metadata to the same content. Additionally, software that automatically adds metadata to content may use various different metadata structures depending, for example, upon the version or manufacturer of the software. Accordingly, a device, such as a mobile terminal that is in communication with other devices, that is queried by an application that functions using metadata, for example, for searching, linking events or objects, etc. may be required to go to various different devices and sort through the various different metadata structures to find relevant content. As such, the device may require complex interfaces capable of dealing with potentially different metadata structures at each node.

Accordingly, it may be desirable to provide a framework for overcoming at least some of the disadvantages discussed above.

### BRIEF SUMMARY

A method, apparatus and computer program product are therefore provided for providing an adaptive framework for a metadata-context switch. In particular, a method, apparatus and computer program product are provided that create a mechanism for specifying to a framework whether a response to a query should be generated in either a metadata view or a context view format. Additionally, a mechanism is further provided for enabling a particular application to provide requirements to the framework to specify rules to be used for generation of the metadata view.

In one exemplary embodiment, a method of providing an adaptive framework for a metadata-context switch is provided. The method may include receiving, from an application, a query for data and determining whether to provide a response to the query in a context view or in a metadata view based on an indication received from the application. The method may further include, in response to determining to provide the response in the metadata view, generating the metadata view based at least in part on a context model and rules specified by the application.

In another exemplary embodiment, a computer program product for providing an adaptive framework for a metadata-context switch is provided. The computer program product includes at least one computer-readable storage medium having computer-readable program code portions stored therein. The computer-readable program code portions include first, second and third executable portions. The first executable portion is for receiving, from an application, a query for data. The second executable portion is for determining whether to provide a response to the query in a context view or in a metadata view based on an indication received from the application. The third executable portion is for generating the metadata view based at least in part on a context model and rules specified by the application in response to determining to provide the response in the metadata view.

In another exemplary embodiment, an apparatus for providing an adaptive framework for a metadata-context switch is provided. The apparatus may include a processing element. The processing element may be configured to receive, from an application, a query for data, to determine whether to provide a response to the query in a context view or in a metadata view based on an indication received from the application, and to generate the metadata view based at least in part on a context model and rules specified by the application in response to determining to provide the response in the metadata view.

In another exemplary embodiment, an apparatus for providing an adaptive framework for a metadata-context switch is provided. The apparatus includes means for receiving, from an application, a query for data, means for determining whether to provide a response to the query in a context view or in a metadata view based on an indication received from the application, and means for, in response to determining to provide the response in the metadata view, generating the metadata view based at least in part on a context model and rules specified by the application.

Embodiments of the invention may provide a method, apparatus and computer program product for employment in a content sharing or managing environment. As a result, for example, mobile terminal users may enjoy improved capabilities with respect to content such as media content for operations such as creating, modifying, sharing, processing, or the like, performed on the content.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a system for providing an adaptive framework for a metadata-context switch according to an exemplary embodiment of the present invention; and

FIG. 3 is a block diagram according to an exemplary method for providing an adaptive framework for a metadata-context switch according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

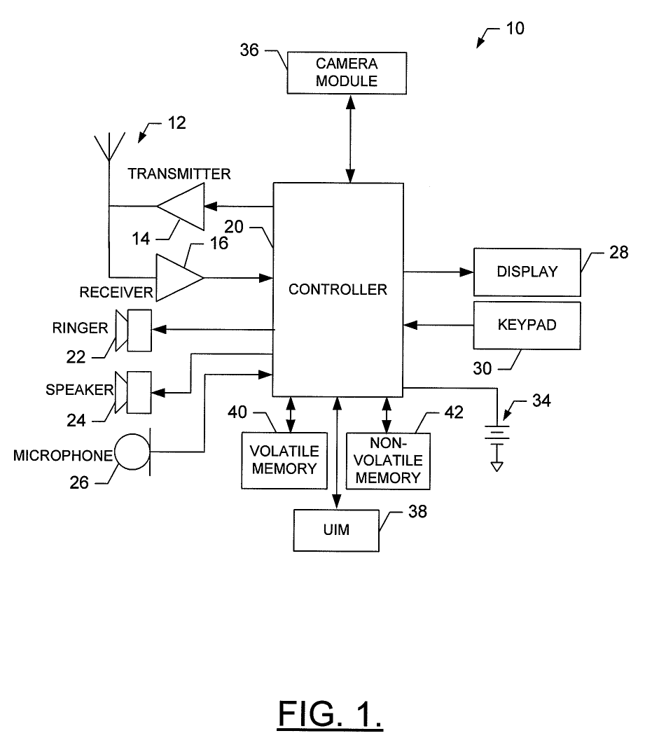

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a ringer 22, a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a media capturing element, such as a camera, video and/or audio module, in communication with the controller 20. The media capturing element may be any means for capturing an image, video and/or audio for storage, display or transmission. For example, in an exemplary embodiment in which the media capturing element is a camera module 36, the camera module 36 may include a digital camera capable of forming a digital image file from a captured image. As such, the camera module 36 includes all hardware, such as a lens or other optical component(s), and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to a JPEG standard format.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

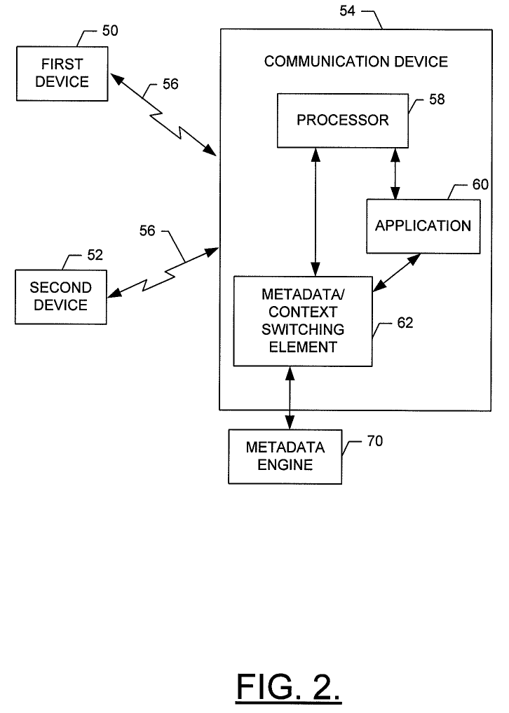

An exemplary embodiment of the invention will now be described with reference to FIG. 2, in which certain elements of a system for providing an adaptive framework for a metadata-context switch are displayed. The system of FIG. 2 may be employed, for example, in conjunction with the mobile terminal 10 of FIG. 1. However, it should be noted that the system of FIG. 2, may also be employed in connection with a variety of other devices, both mobile and fixed, and therefore, embodiments of the present invention should not be limited to application on devices such as the mobile terminal 10 of FIG. 1. It should also be noted that while FIG. 2 illustrates one example of a configuration of a system for providing an adaptive framework for a metadata-context switch, numerous other configurations may also be used to implement embodiments of the present invention.

Referring now to FIG. 2, a system for providing an adaptive framework for a metadata-context switch is provided. The system may include at least a first device 50 and possibly also a second device 52 and other devices in communication with a communication device 54 via a communication link 56. In an exemplary embodiment, the communication link 56 may be a short range wireless communication link such as, for example, Bluetooth, which is defined as an open radio-frequency standard that enables cable-free voice and data communication between devices through short-range two-way radio (in the radio frequency range of about 2.4 gigahertz).

The communication device 54 may be, for example, the mobile terminal 10 of FIG. 1. As such, the communication device 54 may operate under the control of a processing element such as processor 58 (e.g., the controller 20). A processing element such as those described herein may be embodied in many ways. For example, the processing element may be embodied as a processor, a coprocessor, a controller or various other processing means or devices including integrated circuits such as, for example, an ASIC (application specific integrated circuit). The communication device 54 may include memory capable of storing instructions which may be encoded in the memory. The stored instructions may correspond to one or more applications such as application 60, which, when executed, may perform a corresponding function or functions. In an exemplary embodiment, the communication device 54 may also include a metadata/context switching element 62 according to an embodiment of the present invention.

The metadata/context switching element 62 may be any device or means embodied in either hardware, software, or a combination of hardware and software configured to perform the respective functions associated with the metadata/context switching element 62 as described below. In an exemplary embodiment, the metadata/context switching element 62 may be embodied in software as instructions that are stored in the memory of the communication device 54 and executed by the processor 58. Alternatively, the metadata/context switching element 62 may be embodied as software that forms a part of or is installed on middleware, for example, of the communication device 54. As another alternative, the metadata/context switching element 62 may be embodied as the processor 58.

The metadata/context switching element 62 may be configured to develop a context model including a model representation of all devices in communication with the communication device 54. Accordingly, when, for example, a communication session is established between the communication device 54 and the first device 50 and/or the second device 52, the metadata/context switching element 62 may be configured to determine a model representation of the first device 50 and/or the second device 52 with respect to the content and characteristics of the corresponding device. As such, for example, if the first device 50 is a text-to-speech (TTS) device, the context model may include capabilities and other characteristics of the TTS device. The context model may include an object registry (e.g., object model) including an object representation of each corresponding object stored in the corresponding device. Accordingly, for each object created at the corresponding device, information about the characteristics, capabilities, data structure, manufacturer, version number, and other like information may be determined by the metadata/context switching element 62.

Given that the metadata/context switching element 62 may utilize the communication link 56 to establish communications with other devices such as the first and second devices 50 and 52 in order to establish a corresponding context model of the first and second devices 50 and 52, it may be appreciated that the communication device 54 may utilize the context model in order to locate data requested by the application 60 based on context data that may be associated with the data. However, as described above, some applications may function using metadata rather than context data, and there may be complications often associated with utilizing metadata between different devices, since the different devices may have widely diverse metadata structures. Accordingly, searching for metadata associated with content or data on a different device may be complex since an interface for searching for desirable metadata at each level may be required within a hierarchy of data to enable identification of the desirable metadata. Thus, for example, in response to a query for context data being received from the application 60, the communication device 54 may provide context data (e.g., associated with data from other devices) to the application 60. In other words, the communication device 54 may provide a context view of data in response to a query. However, if the communication device 54 were merely a conventional device, the communication device 54 may not be capable of efficiently providing metadata associated with data from other devices to the application 60. Accordingly, in order to provide an ability to efficiently provide metadata to the application 60 in response to a query for such information, embodiments of the present invention include the metadata/context switching element 62, which is further configured as described below. In this regard, the metadata/context switching element 62 is also configured to enable using the context model in order to provide a metadata view of data in response to a query.

As may be determined from the preceding, context data may be represented in a hierarchical manner that is logically organized and linked to other context data. For example, when the communication device 54 establishes a communication session with the first and/or second devices 50 and 52, the metadata/context switching element 62 may establish a context model providing an object representation of data associated with the corresponding devices, which may be linked, for example, by the application 60, via correlations in the context data of various objects to a particular query issued by the application 60. However, implementers are largely free to define their own data types, data structures and thus, metadata type definitions. Accordingly, metadata may include simple structures defining and giving a basic set of data that can be locally represented within a metadata interface (e.g., a DCI metadata interface) or metadata may be relatively complex such that a separate metadata engine may be employed. In cases where complex metadata is utilized, rather than storing the metadata with the associated data or content, the metadata may be stored in a separate entity. As such, a uniform resource identifier (URI) may point to metadata or to a set of processing instructions for constructing the metadata at the metadata engine.

The metadata/context switching element 62 may be configured to determine, in response to receipt of a query from the application 60, whether the query is requesting a context view or a metadata view for responding to the query. For example, an indication received from the application 60 may be used in making such a determination. If the context view is requested, the metadata/context switching element 62 may be configured to provide a response to the query by providing a context view based on the context model. However, if the metadata view is requested, the metadata/context switching element 62 may be configured to provide a response to the query by providing a metadata view based on an indication of what rules should be used for generating the metadata view based on the context model.

In this regard, the metadata/context switching element 62 may be configured to interpret a rule set for metadata generation and generate metadata from the context model based on the rule set. The rule set used for generation of the metadata may be defined in a plurality of ways. In an exemplary embodiment, the rule set may be defined by the application 60 via an instruction to use a rule set provided by the application 60. In other words, the application 60 may forward a rule set to be used for generating metadata directly to the metadata/context switching element 62 (or to a metadata engine). In one alternative exemplary embodiment, the rule set may be stored at another location accessible to the metadata/context switching element 62, and the application 60 may forward a URI or address of the rule set to be used to the metadata/context switching element 62 in order to enable the metadata/context switching element 62 to access the rule set. As another alternative embodiment, the rule set may be a default rule set. Accordingly, in one exemplary embodiment, the application 60 may provide instructions as to whether to use a default rule set, a rule set having a location identified by the application 60 or a rule set provided by the application 60. The metadata/context switching element 62 may then use the rule set specified in the instructions received from the application 60 to generate metadata for the metadata view based on the rule set and the context model.

Accordingly, when an application uses context data, the metadata/context switching element 62 may provide a context value through a value interface associated with the metadata/context switching element 62 (e.g., a DCIProperty value interface). However, when an application requests metadata, the metadata/context switching element 62 may switch to a metadata view by using specified rules to provide a metadata value to the value interface. Thus, when a metadata view is requested, the metadata/context switching element 62 does not merely swap metadata and value interfaces. Rather, the metadata/context switching element 62 constructs a hierarchy of, for example, a DCI tree based on metadata characteristics that either follow metadata ontology or provide a logical organization.

In an exemplary embodiment, the metadata/context switching element 62 may be in communication with a metadata engine 70. The metadata engine 70 may be any device or means embodied in either hardware, software, or a combination of hardware and software configured to generate metadata according to a defined set of rules. As stated above, metadata is often considered as being static information. However, given the ability of the metadata/context switching element 62 according to embodiments of the present invention to generate metadata according to specified rules, the metadata engine 70, which may be in communication with or a portion of the metadata/context switching element 62, may be capable of generating dynamic metadata. Alternatively, the metadata/context switching element 62 may itself be configured to generate the dynamic metadata. In this regard, in an exemplary embodiment, the system of FIG. 2 may further include one or more event listeners in communication with the metadata engine 70 (and/or the metadata/context switching element 62) to listen for context data changes. In the event of a context data change, an event listener (e.g., a device configured to perform a particular function in response to the occurrence of a particular event) may inform the metadata engine 70 of the change in context data and the metadata engine 70 may apply the current rule set to generate metadata responsive to the change in context data. Accordingly, the changes in context data may trigger generation of new metadata, thereby making the metadata dynamic without a need for an event based mechanism. However, in some embodiments in which metadata depends on parameters other than context, an event based mechanism in combination with a query mechanism may be employed, for example, as a portion of a DCI framework, to achieve a similar result.

In an exemplary embodiment, the metadata/context switching element 62 may be configured to make the determination regarding whether the application 60 is requesting a context view or a metadata view based on a parameter. For example, the metadata/context switching element 62 may provide a DCI framework for use in connection with a browser's getFeature method (e.g., DOM interface) to receive a parameter defining the type of view to be provided to the application 60. The parameter may therefore be considered as a view parameter since it defines the view that should be presented to the application 60. In an exemplary embodiment, view parameter values could be defined as follows:
Null: a default value defining that the context view is to be provided;
URI: a URI pointing to a particular ontology to specify that the particular ontology is to be used for providing the view;
MData: defining that a metadata view is expected, which may be generated according to default metadata view generation rules employed by an implementation;
MData_Time: defining that the metadata view is expected and the view is to be arranged according to time data in metadata;
MData_Date: defining that the metadata view is expected and the view is to be arranged according to date data in metadata; and
MData_URI: defining that the metadata view is expected and the view is to be arranged according to rules provided by an external URI.
   However, it should be appreciated that the view parameter values above are merely exemplary and other values for the functionalities listed, and even other functionalities may be provided by the view parameter values.

Thus, the metadata/context switching element 62 may be configured to generate the context view or the metadata view dependent upon the view parameter provided by the application 60. Furthermore, if the view parameter specifies the metadata view, the metadata/context switching element 62 may be configured to generate (e.g., using the metadata engine 70 in some instances) metadata based on a rule set specified by the application 60 and also based on the context model. Accordingly, logical organization of nodes within the metadata view may follow requirements or requests provided by the application 60. Thus, for example, nodes may be organized based on characteristics such as time of addition (or other characteristics when times match), date of addition, version number, manufacturer, etc. that may be favorable to the application 60. However, the name of the node may remain the same (and the namespace) for both the context view and the metadata view since the metadata value is generated, at least in part, based upon the context value provided by the context model. The value of the context view may then also form the metadata value in the metadata view as provided, for example, by the DCI framework established by virtue of the metadata/context switching element 62 which computes a value of metadata and provides the computed value through the value interface such as the DCIProperty. Metadata values may be computed for several characteristics such as, for example, version number, manufacturer, location based information, date based information, time based information (e.g., the last time an object was accessed by a particular application), and/or the like.

In order to support context based metadata generation, it may be desirable to increase the events supported by the DCI framework. Thus, for example, a generic “data_change” event characterizing a change in a value held by the metadata interface may be performed to expand the number of events recognized. Accordingly, changes in context data corresponding to an increased number of events may be recognized and new metadata values may correspondingly be computed. For example, metadata may be generated to give more importance to events that occurred longer ago by defining an event to be the passage of a predetermined amount of time. Thus, after passage of the predetermined amount of time, metadata for corresponding content may be updated to reflect the importance of the event.

In an exemplary embodiment, different rule sets may be used for different types of objects. Accordingly, the metadata/context switching element 62 may be configured to sort each type of object and determine corresponding metadata values for the different types of objects based on rules, which may be different, for each of the different types of objects.

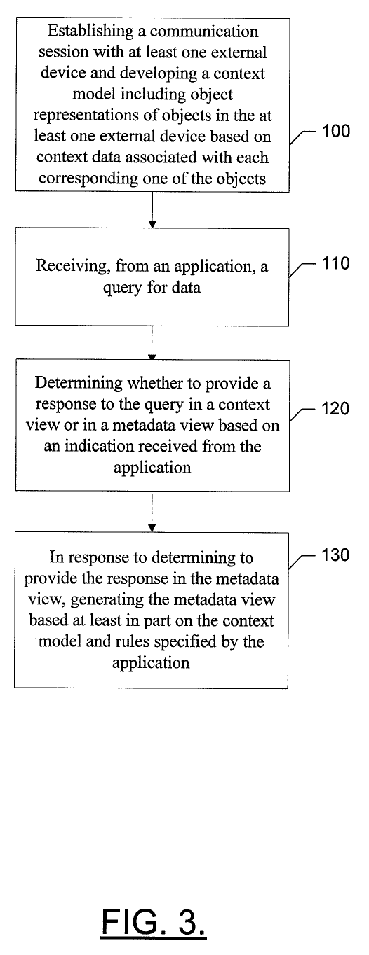

FIG. 3 is a flowchart of a method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, a method according to one embodiment of the invention, as shown in FIG. 3, may include an optional initial operation of establishing a communication session with at least one external device and developing a context model including object representations of objects in the at least one external device based on context data associated with each corresponding one of the objects at operation 100. At operation 110, a query for data may be received from an application. A determination may be made at operation 120 as to whether to provide a response to the query in a context view or in a metadata view based on an indication received from the application. The indication may include a view parameter. At operation 130, in response to determining to provide the response in the metadata view, the metadata view may be generated based at least in part on the context model and rules specified by the application. In an exemplary embodiment, the rules may include a rule set that is at a location identified by an address such as a URI provided by the application, a rule set that is provided by the application, or a default rule set. In an exemplary embodiment, the rules may include different rules corresponding to different types of objects.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving, from an application, a query for data;
determining whether to provide a response to the query in a context view or in a metadata view based on an indication received from the application; and
in response to determining to provide the response in the metadata view, generating the metadata view based at least in part on a context model and rules specified by the application.

2. A method according to claim 1, further comprising an initial operation of establishing a communication session with at least one external device.

3. A method according to claim 2, further comprising developing the context model including object representations of objects in the at least one external device based on context data associated with each corresponding one of the objects.

4. A method according to claim 1, wherein generating the metadata view comprises generating the metadata view based at least in part on a rule set at a location identified by an address provided by the application.

5. A method according to claim 1, wherein generating the metadata view comprises generating the metadata view based at least in part on a rule set provided by the application.

6. A method according to claim 1, wherein generating the metadata view comprises generating the metadata view based at least in part on a default rule set.

7. A method according to claim 1, wherein generating the metadata view comprises generating the metadata view based at least in part on different rules corresponding to different types of objects.

8. A method according to claim 1, wherein determining whether to provide a response to the query comprises determining whether to provide a response to the query in the context view or in the metadata view based on a view parameter received from the application.

9. A computer program product comprising at least one computer-readable storage medium having computer-readable program code portions stored therein, the computer-readable program code portions comprising:
a first executable portion for receiving, from an application, a query for data;
a second executable portion for determining whether to provide a response to the query in a context view or in a metadata view based on an indication received from the application; and
a third executable portion for generating the metadata view based at least in part on a context model and rules specified by the application in response to determining to provide the response in the metadata view.

10. A computer program product according to claim 9, further comprising a fourth executable portion for an initial operation of establishing a communication session with at least one external device.

11. A computer program product according to claim 10, further comprising a fifth executable portion for developing the context model including object representations of objects in the at least one external device based on context data associated with each corresponding one of the objects.

12. A computer program product according to claim 9, wherein the third executable portion includes instructions for generating the metadata view based at least in part on a rule set at a location identified by an address provided by the application.

13. A computer program product according to claim 9, wherein the third executable portion includes instructions for generating the metadata view based at least in part on a rule set provided by the application.

14. A computer program product according to claim 9, wherein the third executable portion includes instructions for generating the metadata view based at least in part on a default rule set.

15. A computer program product according to claim 9, wherein the third executable portion includes instructions for generating the metadata view based at least in part on different rules corresponding to different types of objects.

16. A computer program product according to claim 9, wherein the second executable portion includes instructions for determining whether to provide a response to the query in the context view or in the metadata view based on a view parameter received from the application.

17. An apparatus comprising a processing element configured to:
receive, from an application, a query for data;
determine whether to provide a response to the query in a context view or in a metadata view based on an indication received from the application; and
generate the metadata view based at least in part on a context model and rules specified by the application in response to determining to provide the response in the metadata view.

18. An apparatus according to claim 17, wherein the processing element is further configured to perform an initial operation of establishing a communication session with at least one external device.

19. An apparatus according to claim 18, wherein the processing element is further configured to develop the context model including object representations of objects in the at least one external device based on context data associated with each corresponding one of the objects.

20. An apparatus according to claim 17, wherein the processing element is further configured to generate the metadata view comprises generating the metadata view based at least in part on a rule set at a location identified by an address provided by the application.

21. An apparatus according to claim 17, wherein the processing element is further configured to generate the metadata view comprises generating the metadata view based at least in part on a rule set provided by the application.

22. An apparatus according to claim 17, wherein the processing element is further configured to generate the metadata view comprises generating the metadata view based at least in part on a default rule set.

23. An apparatus according to claim 17, wherein the processing element is further configured to generate the metadata view comprises generating the metadata view based at least in part on different rules corresponding to different types of objects.

24. An apparatus according to claim 17, wherein the indication received from the application comprises a view parameter.

25. An apparatus comprising:
means for receiving, from an application, a query for data;
means for determining whether to provide a response to the query in a context view or in a metadata view based on an indication received from the application; and
means for generating the metadata view based at least in part on a context model and rules specified by the application in response to determining to provide the response in the metadata view.

26. An apparatus according to claim 25, further comprising:
means for an initial operation of establishing a communication session with at least one external device; and
means for developing the context model including object representations of objects in the at least one external device based on context data associated with each corresponding one of the objects.
